(19) United States
(12) Patent Application Publication
(10) Pub. No.: US 2001/0013688 A1
(43) Pub. Date: Aug. 16, 2001

(54) Tandem stroller & brake assembly thereof

(76) Inventors: Robert J. Warner JR., Akron, OH (US); Leland M. Faa, Malvern, OH (US); Kirk C. Palmerton, Kent, OH (US)

Correspondence Address: Mary Michelle Kile, FOLEY & LARDNER, Washington Harbour, 3000 K Street, N.W., Suite 500, Washington, DC, 20007-5109, US

(21) Appl. No.: 09/770,467

(22) Filed: Jan. 29, 2001

Related U.S. Application Data
(62) Division of application No. 09/421,532, filed on Oct. 20, 1999.
(60) Provisional application No. 60/136,131, filed on May 25, 1999.

(51) Int. Cl. B62B 7/00

(52) U.S. Cl. 280/47.38; 280/647; 188/19

(57) ABSTRACT

A tandem stroller has a stroller frame, a forward carriage portion attached to the frame and adapted to carry a first child, and a rearwardly facing seat attached to the frame and adapted to permit a second child to sit behind the forward carriage portion, with the second child facing in a rearward direction. The tandem stroller also includes a flexible seat back for the rearwardly facing seat, a pivotable standing platform, a gripping bar for the second child to grasp while standing on the standing platform, a removable tote, and a brake mechanism for the rear wheels. The forward carriage portion of the tandem stroller further includes a pivotable seat back that pivots between a first position and a second, substantially upright position to provide head clearance for the second child seated behind the forward carriage portion. The stroller also includes a brake mechanism having a safety feature. The brake mechanism can be applied to any stroller.

This application claims the benefit of U.S. Provisional Application No. 60/136,131, filed May 25, 1999, incorporated herein by reference in its entirety.

### BACKGROUND

Tandem strollers appearing in the past have enjoyed success. Tandem strollers are attractive to parents and other child caregivers who must watch two children simultaneously because both children can be wheeled in the same stroller assembly. A common orientation of tandem strollers is those in which the two children sit side-by-side and both children face forward. Alternatively, the rear child seat can be positioned directly behind the front child's seat. Examples of such strollers with forwardly facing child seats, one behind the other, are disclosed in U.S. Pat. No. 3,309,101; No. 4,725,071; No. 5,642,152; No. 5,722,682; Des. No. 311,363; Des. No. 328,047; Des. No. 359,937; and Des. No. 370,437. In a modification of this tandem stroller arrangement, the rear child seat is at an elevated position behind the front child seat. This modified arrangement is shown, for example, in U.S. Pat. No. 5,653,460 and Des. No. 360,392. In yet another seating orientation, the front child seat faces forward and the rear child seat is elevated and faces backward, for example, as disclosed in U.S. Pat. No. 4,728,112.

Tandem strollers have also been designed so that the front child seat faces the rear child seat. Two children sitting on the two seats then can play with each other. This type of tandem stroller is disclosed in U.S. Pat. No. 5,018,754; No. 5,050,900; No. 5,167,425; No. 5,333,893; No. 5,338,096; No. 5,769,448; and No. 5,911,432. In some of these strollers, the front child seat can be changed between a front facing position and a rear facing position so that, when the stroller is stationary, the children can face each other and play and, when the stroller is moving, the children both face forward. It is also known to construct the tandem stroller so that both the rear child seat, as well as the front child seat, can be changed between a forward facing position and a rearward facing position. U.S. Pat. No. 4,542,915 discloses such a tandem stroller.

To accommodate toddlers, who often become fussy if required to sit for a prolonged period of time, some strollers include a standing platform for the toddler. U.S. Pat. Des. No. 387,019 shows such a stroller. A smaller child can be seated in the front child seat, while a more active toddler can stand in the back. One drawback of this stroller is that, if the toddler becomes tired, there is nowhere for the toddler to sit. In addition to a rear pedal for standing, U.S. Pat. No. 5,664,795 discloses a stroller with a back seat plate upon which the toddler can sit. The back seat plate is disposed beneath a back plate of the front child seat. When not in use, the back seat plate fastens to the back plate of the front child seat. When in use, the back seat plate fastens to the basket frame of the stroller. The back seat plate of this stroller is mounted so closely to the back plate of the front child seat, however, that the back plate of the front child seat must remain in a fully upright position to provide enough room for the child to sit in back.

The known tandem strollers discussed above can be improved upon to make them better suited to accommodate two children. For example, a consideration in tandem strollers is storage space. Two children necessarily double the amount of child accessories to be carried on any outing. Consumers would welcome a tandem stroller that maximizes the amount of storage space.

The difficulties suggested in the preceding are not intended to be exhaustive but rather are among many that can reduce the effectiveness of prior tandem strollers. Other noteworthy problems may exist; however, those presented above should be sufficient to demonstrate that tandem strollers appearing in the past will admit to worthwhile improvement.

### SUMMARY OF THE INVENTION

This invention relates to a tandem stroller and a brake assembly thereof. More particularly, this invention relates to a tandem stroller suited for wheeling a forward facing infant and a toddler, such that the toddler has the option of comfortably sitting in a rearwardly facing seat or standing on a standing platform and facing forward.

The present invention provides a multi-feature tandem stroller that comprises a stroller frame, a forward carriage portion attached to the frame and adapted to carry a first child, and a rearwardly facing seat adapted for a second child to sit behind the forward carriage portion, facing in a rearward direction.

The stroller frame can include first and second front legs, each having a first end attached to a respective front wheel; first and second rear legs, each having a first end attached to or terminating at a respective rear wheel and a second end pivotally attached to or terminating at a second end of the respective first and second front legs. The stroller frame can includes a push bar having a gripping portion and first and second push bar legs extending from the gripping portion, the first and second push bar legs being pivotally attached to the first and second rear legs, respectively. The stroller frame further includes first and second side support members each having a first end and a second end. The first side support member is pivotally attached to the first front leg and the first rear leg, and the second side support member is pivotally attached to the second front leg and the second rear leg. The stroller frame can further include a rear cross member extending between the first and second rear legs.

The rearwardly facing seat can be structurally independent of the forward carriage portion and a flexible seat back. The rearwardly facing seat can be attached to the first and second side support members at a location rearward of the first and second rear legs and extend over the second ends of the first and second side support members. The rearwardly facing seat can include a seat base (or a rigid seat portion) and a flexible seat back. The flexible seat back can be pushed or pivoted downward by the child caregiver so that the child caregiver can easily access a storage compartment, such as a storage basket, located beneath the forward carriage portion. The flexible seat back of the rearwardly facing seat is moveable in a direction toward the rigid seat portion to allow access to the storage compartment.

The tandem stroller can also include a standing platform attached to the stroller frame, extending between the first and second rear legs. The standing platform is positioned below the rearwardly facing seat, and at least a portion of the standing platform is positioned rearwardly of the rearwardly facing seat. The standing platform is configured to support the toddler in a standing position, with the toddler facing in a forward direction. The standing platform can double as a footrest for the toddler when the toddler is seated on the rearwardly facing seat. The standing platform is connected to the stroller frame to pivot upward about an edge of the platform that is closest to the rearwardly facing seat. The standing platform can be pivoted upward to provide increased walking clearance for the child caregiver when, for example, the toddler is not in the stroller. Specifically, the standing platform can have a first edge, a second edge, and a neck on the first edge, where the neck can be pivotally attached to the rear cross member. The standing platform can pivot on the rear cross member between a first lowered position and a second upright position.

The stroller frame can further include a push bar cross member extending between the push bar legs. A canopy for the forward carriage portion of the stroller can be mounted to the push bar cross member by straps. The cross member can be exposed between the straps so that, when the toddler stands, the toddler can grip the exposed portions of the push bar cross member. Cushioning can surround the push bar cross member so that the push bar cross member is soft and somewhat pliable, providing a comfortable grip area for the toddler. The tandem stroller can also include an awning joined to the canopy and releasably attachable to the push bar legs to extend over the rearwardly facing seat.

The tandem stroller can also have increased storage space. In this connection, a first storage compartment can be removably fastened or attached to the stroller frame and located below the forward carriage portion. Specifically, the first storage compartment can be removably fastened to the first and second side support members. Further, a second storage compartment, such as a zippered bag, can be removably fastened or attached to a lower surface of the rearwardly facing seat. This second storage compartment also can be removably fastened to a rear surface of the first storage compartment. The second storage compartment can hold toys, bottles, and other child care items.

The forward carriage portion of the tandem stroller can include a seat back. The stroller frame can further include a seat back frame member connected to the first and second side support members. The seat back frame member can have first and second seat back legs and a seat back cross member pivotally connected to the first and second seat back legs via a pivot assembly (or a first or second pivot assemblies, respectively). An upper portion of the seat back of the forward carriage portion can be mounted to the seat back cross member. The pivot assembly (or assemblies) is adapted to pivot the seat back cross member, and hence the upper portion of the seat back (relative to the first and second seat back legs), from a first position to a second, substantially upright position. This adjustment of the seat back provides clearance for a toddler sitting in the rearwardly facing seat. In general, the forward carriage portion can be positioned in a reclined position, a middle position, or an elevated position. At any one of these positions, the upper portion of the seat back can be adjusted between the first position and the second, substantially upright position.

As a safety feature, the tandem stroller has a brake mechanism adjacent each rear wheel. A brake mechanism for a stroller according to the invention comprises a brake housing, a brake lever, and a brake safety member. The housing is adapted to connect to a stroller frame. The brake lever can be pivotally mounted to the brake housing and movable between a brake engaged position and a brake disengaged position. The brake lever has a brake sprocket engaging member adapted to engage a brake sprocket of a stroller wheel. The brake safety member is mounted to the housing and movable between an ON position and an OFF position.

The brake safety member can operatively engage the brake lever to lock the brake lever from moving toward the brake disengaged position when the brake safety member is in the ON position. The brake safety member allows the brake lever to move to the brake disengaged position when the brake safety member is in the OFF position. An additional aspect of the invention is that the tandem stroller provides a shield adapted to cover a wheel and shroud the brake sprocket.

### BRIEF DESCRIPTION OF THE DRAWINGS

Other objects and advantages of the present invention will become apparent from the following detailed description of a preferred embodiment thereof taken in conjunction with the accompanying drawings, wherein:

FIG. 1 is a perspective view of a tandem stroller in accordance with the invention;

FIG. 1A is a schematic view of a stroller frame for a tandem stroller according to the present invention;

FIG. 2 is a partial rear perspective view of the tandem stroller of FIG. 1 according to the present invention;

FIG. 2A is an enlarged detail view of locking mechanism for adjustment of a seat back of a forward carriage portion according to the invention;

FIG. 3 is a top view of a rearwardly facing seat of a tandem stroller according to the present invention;

FIG. 4 is a bottom perspective view of a standing platform of a tandem stroller according to the present invention;

FIG. 4A is a perspective view of a mounting bracket for the standing platform according to the present invention;

FIG. 5 is a perspective detail view of a standing platform of a tandem stroller, where the standing platform is in a pivoted position, according to the present invention;

FIG. 6 is a perspective detail view of a rearwardly facing seat of a tandem stroller according to the present invention;

FIG. 7 is a schematic view of a seat back frame member of a tandem stroller according to the present invention;

FIG. 8 is a partial side perspective view of a seat back of a forward carriage portion in a first position, according to the present invention;

FIG. 9 is a side perspective view of a tandem stroller, with the seat back of the forward carriage portion in a second, upright position, according to the present invention;

FIG. 10 is a partial rear perspective view of the tandem stroller according to the present invention;

FIG. 11 illustrates a left rear wheel assembly with a brake mechanism according to the present invention;

FIG. 12 illustrates the brake mechanism of FIG. 11;

FIG. 13 illustrates a housing for the brake mechanism of FIG. 11;

FIGS. 14 and 14A illustrates a cutaway view of the brake mechanism housing, illustrating a wheel suspension assembly;

FIG. 15 schematically illustrates one embodiment of the brake mechanism according to the present invention;

FIG. 16 schematically illustrates another embodiment of the brake mechanism according to the present invention;

FIGS. 16A-16C are perspective views of the components of the brake mechanism of FIG. 16; and

FIG. 17 schematically illustrates the brake mechanism of FIG. 16, where its brake lever is in a brake disengaged position.

### DETAILED DESCRIPTION

The present invention relates to a multi-feature tandem stroller, particularly suited for wheeling active toddlers who grow restless if seated for a prolonged period of time. The multi-feature tandem stroller is configured to accommodate a small child in a forward carriage portion and a toddler behind the forward carriage portion. The toddler is able to either sit or stand due to the structural configuration of the tandem stroller. When the toddler stands and faces forward, he or she can see people passing by and activity happening in front of the stroller. Alternatively, the toddler can sit and face backward, where he or she can see the familiar face of the child caregiver. Likewise, the parent can see the toddler and can reach him easier than when the toddler faces forward. In addition, the toddler has a larger field of view, in general, as compared to tandem strollers where the toddler faces forward and sits behind the canopy of the forward carriage portion.

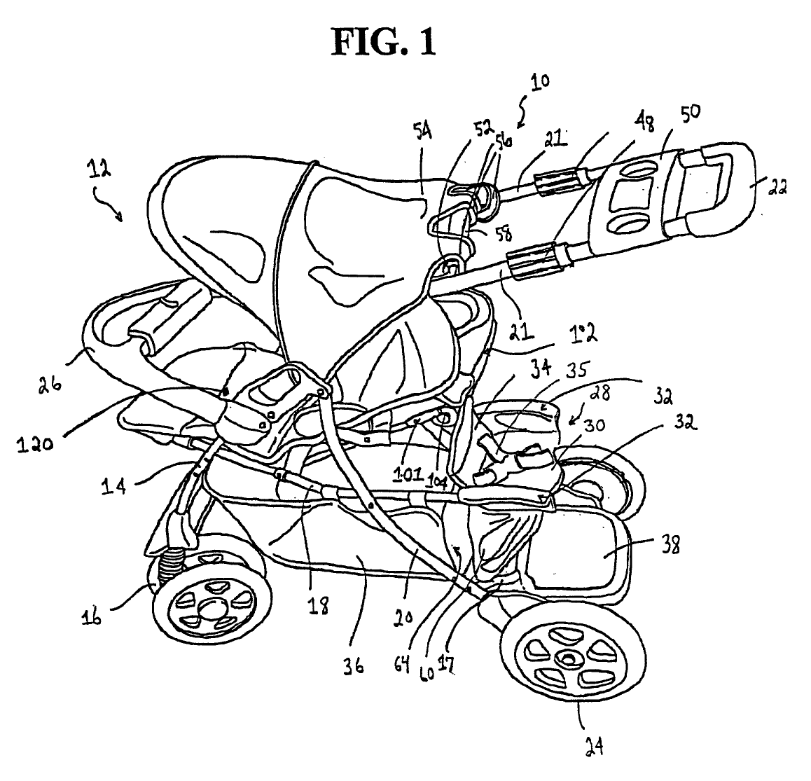

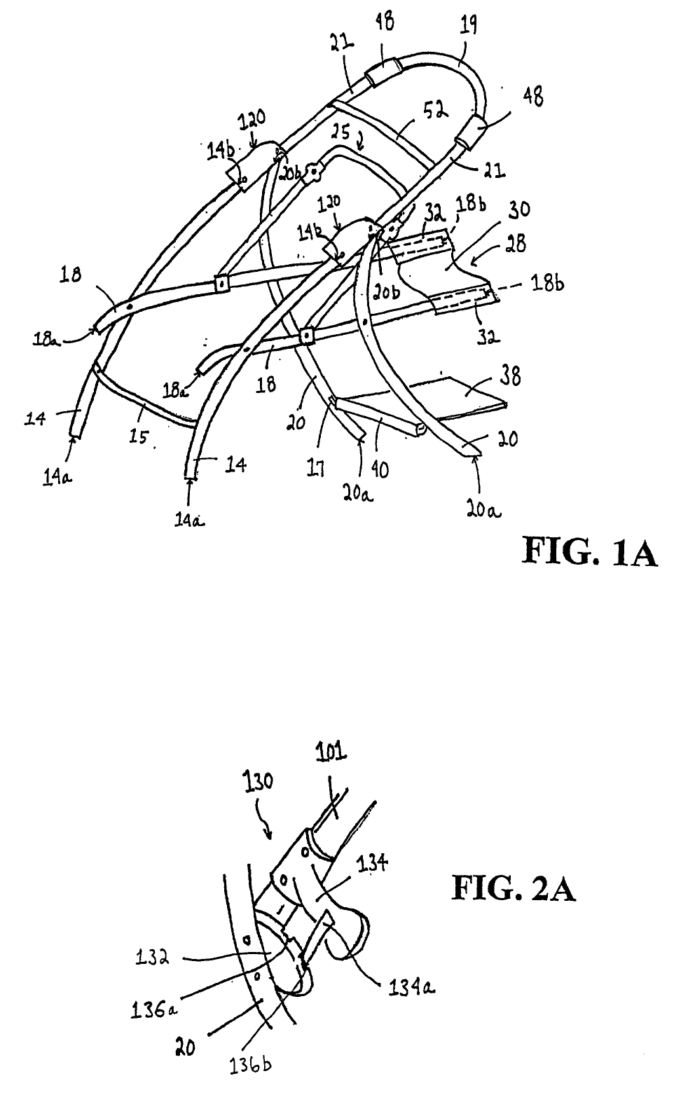

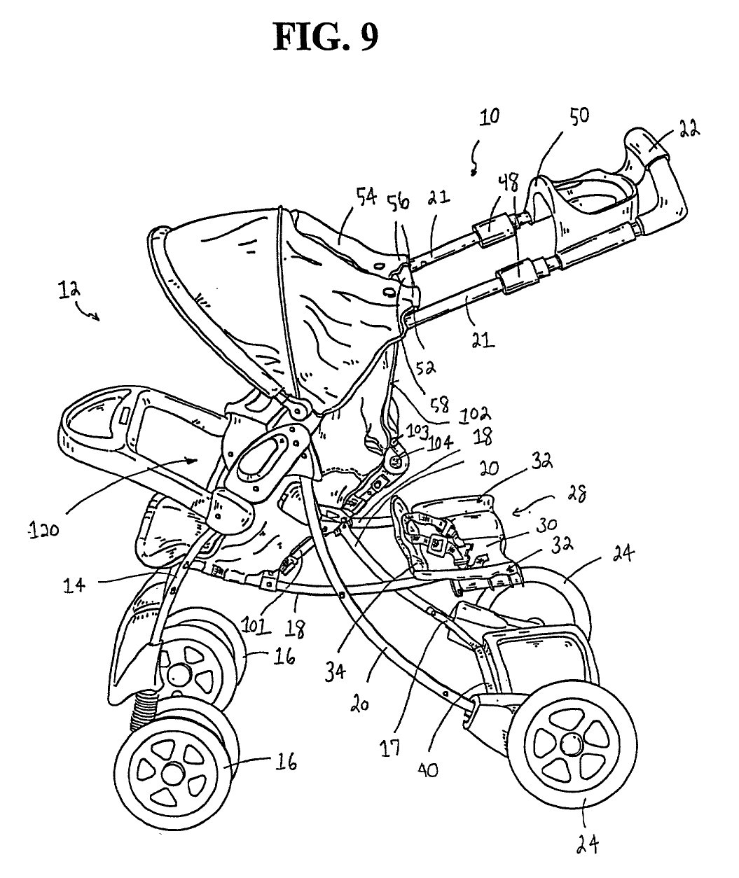

Referring to the drawings, wherein identical numerals indicate like parts, and initially to FIGS. 1 and 9, there will be seen a tandem stroller, generally indicated 10, in accordance with the invention. The tandem stroller 10 includes a stroller frame and a forward carriage portion, generally indicated 12, attached to the stroller frame. The forward carriage portion 12 is particularly suited for an infant child. A second child can be wheeled in the stroller 10 behind the forward carriage portion 12. The second child can either sit on a rearwardly facing seat 28 or stand on a standing platform 38.

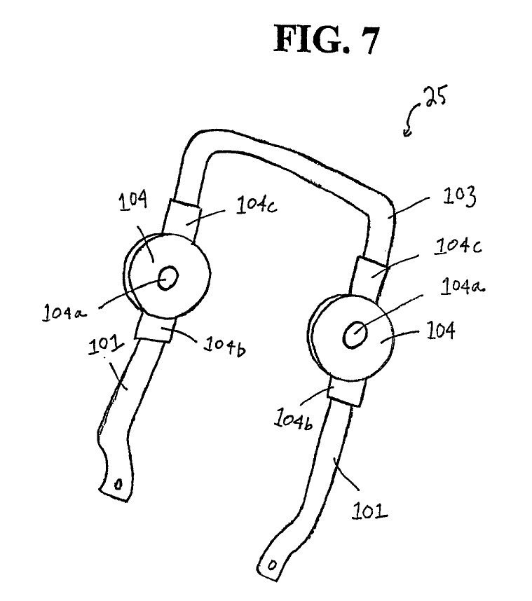

The stroller frame, absent the soft goods and wheels, is shown in FIG. 1A. The stroller frame includes first and second front legs 14, each having a first end 14a attachable to respective front wheel assemblies 16 and a second end 14b. A front cross member 15 extends between the front legs 14. The stroller frame further includes first and second rear legs 20, each having a first end 20a attachable to respective rear wheel assemblies 24 and a second end 20b pivotally attached to the second end 14b of the respective first and second front legs 14. A rear cross member 17 extends between the rear legs 18. A push bar having a gripping portion 19 and first and second push bar legs 21 extending from the gripping portion 19 also form part of the stroller frame. The first and second push bar legs 21 pivotally attach to the first and second rear legs 20, respectively. A push bar cross member 52 extends between the push bar legs 21. The stroller frame also includes first and second side support members 18, each having a first end 18a and a second end 18b. The side support members 18 pivotally attach to the respective front legs 14 and rear legs 20. The second ends 18b of the side support members 18 extend rearward of the rear legs 20. The stroller frame further includes a U-shaped seat back frame member, generally indicated 25, which will be discussed further in connection with FIGS. 7-10. The seat back of the forward carriage portion 12 is mounted to the seat back frame member 25.

The stroller frame of the tandem stroller 10 also includes fold mechanisms 120 on either side of the stroller. These fold mechanisms 120 allows folding of the stroller 10 when not in use. The manner of operation of the fold mechanisms 120 is disclosed in commonly owned, co-pending application Ser. No. 09/178,461, filed Oct. 23, 1998, the disclosure of which is incorporated herein by reference in its entirety, and in commonly owned U.S. Pat. No. 5,454,584, issued Oct. 3, 1995, the disclosure of which is incorporated herein by reference in its entirety.

In addition, a child tray 26 preferably is mounted to the fold mechanisms 120 by, for example, rivets. Although the child tray 26 is not shown in FIG. 1A, once riveted, the child tray 26 forms a permanent part of the stroller frame. FIG. 1 shows the child tray extending between the first and second front legs 14, in front of the forward carriage portion 12. A child seated in the forward carriage portion 12 can use the child tray 26 to rest his or head when sleeping in a forward position or to hold snacks or play things. The child tray 26 also prevents inadvertent bumping of the child from the front.

The rearwardly facing seat 28 of the tandem stroller 10 is attached to the first and second side support members 18 at a position rearward of the first and second rear legs 20. The rearwardly facing seat 28 extends over the second ends 18b of the side support members 18. The side support members 18 extend a sufficient distance rearwardly of, i.e., behind, the rear legs 20 that the rearwardly facing seat 28 can be attached to the side support members 18 without coming into contact with the forward carriage portion 12. Due to this configuration, the second child has adequate sitting space, even if the seat back of the forward carriage portion is in a reclined position. As is most apparent in FIGS. 1A and 9, the rearwardly facing seat 28 is structurally independent of the forward carriage portion 12; that is, the rearwardly facing seat 28 is connected directly to the stroller frame and does not rely on any of the structural elements of the forward carriage portion 12 for attachment to the stroller.

When the toddler is seated in the rearwardly facing seat 28, he or she can see the child caregiver pushing the stroller 10. In this rearwardly facing orientation, the toddler has a wider field of view than in those tandem strollers where the toddler faces forward and sits behind the canopy of the forward carriage portion, which can obstruct the toddler's view. Likewise, the child caregiver can see the toddler and can reach him or her easier than when the toddler faces forward.

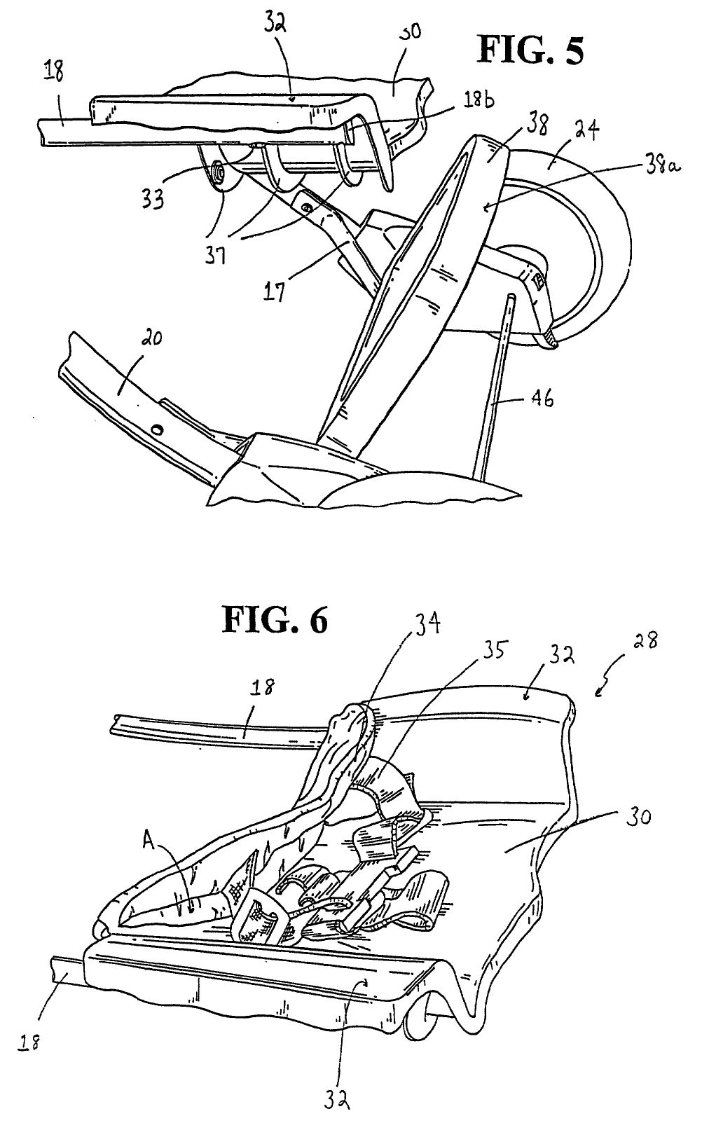

The seat 28 preferably includes a contoured seat base 30 having side bolsters 32 on which the toddler can rest his or her forearms. In addition, the seat base 30 is contoured for comfort. The seat base 30 preferably is formed from a rigid plastic material, such as nylon 6. As shown in FIG. 5, the underside of the seat base 30 can include reinforcement ribs 37 to provide additional strength to the seat base 30.

The rearwardly facing seat 28 is rigidly fastened to the side support members 18. In a preferred embodiment, when the seat base 30 is positioned between the side support members 18 at the rear of the tandem stroller, the side bolsters 32 of the seat base 30 extend over the second ends 18b of the side support members 18, as shown in FIG. 5. The side bolsters 32 are then fastened to the side support members 18 by rivets , e.g., 33, screws, or other suitable fastening elements. In the preferred embodiment, the rearwardly facing seat 28 is not movable or pivotable relative to the side support members 18.

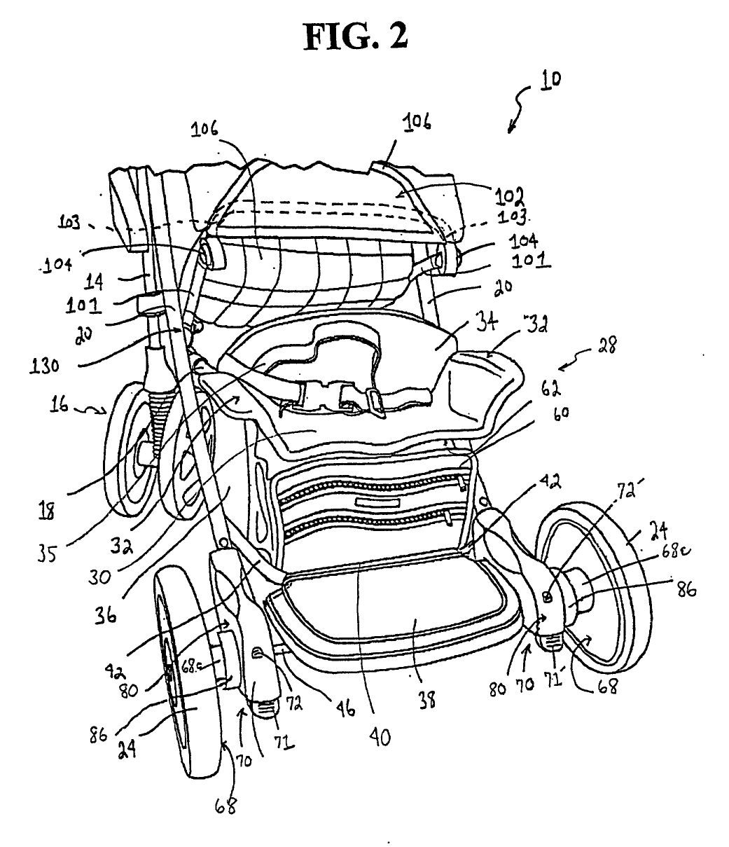

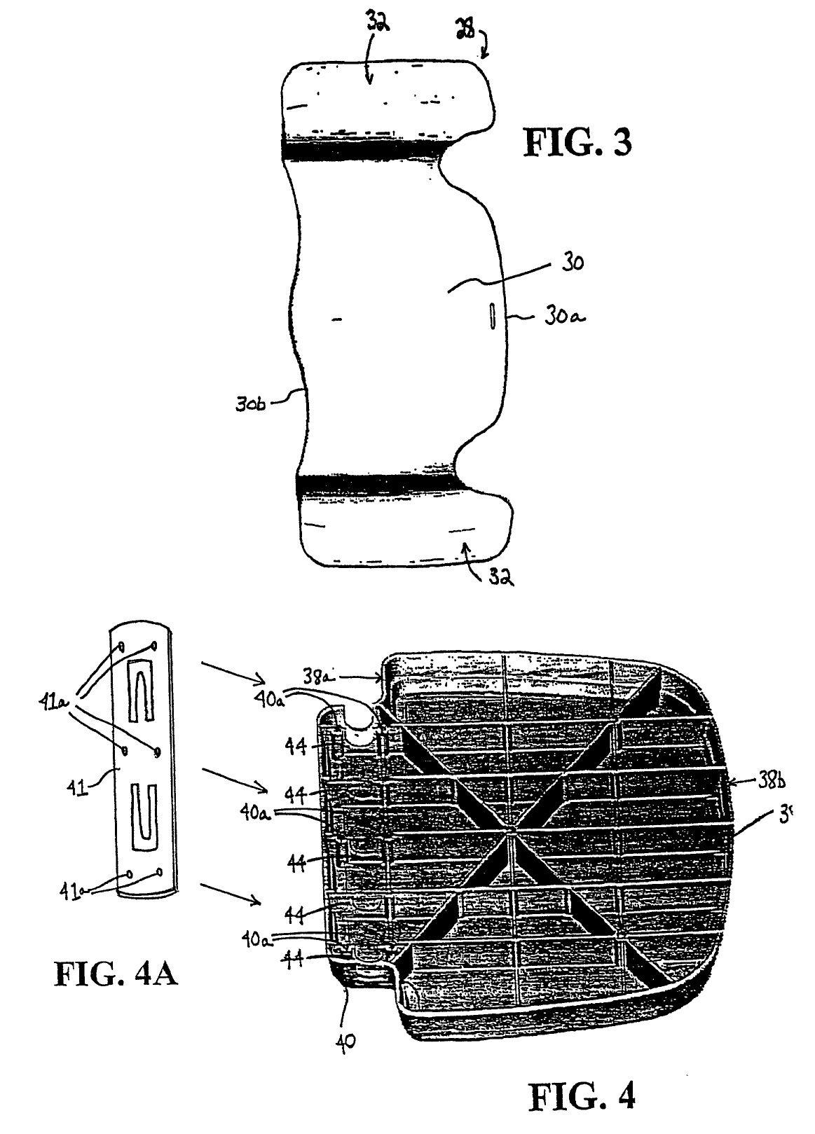

FIG. 3 shows a top view of the seat base 30. The seat base 30 has a first edge 30a and a second edge 30b. As shown in FIGS. 1 and 2, a flexible seat back 34 is attached to the second edge 30b of the seat base 30, and a belt restraint system 35 is attached to the flexible seat back 34 to hold the second child in the seat 28. The belt restraint system 35 generally includes straps and a strap-tightening member. The belt restraint system 35 can be sewn to the flexible seat back 34. In addition to providing a comfortable seat back for the second child, the flexible seat back 34 provides access to a storage compartment located below the forward carriage portion 12 of the tandem stroller 10. The child caregiver can grip and pull downward on the seat back 34 in the general direction of arrow A, as shown in FIG. 6, to access to a storage compartment, such as storage basket 36 in FIG. 1, located beneath the forward carriage portion 12. The seat back 34 can include a layer of polypropylene material underneath a decorative fabric. The polypropylene material provides some rigidity to the seat back 34, yet bends when pulled on by the child caregiver to expose the storage basket 36. The availability and accessibility of stroller storage space is always a concern in tandem strollers. The flexibility of the seat back 34 provides easy access to that storage space.

The tandem stroller 10 of the present invention also includes a standing platform 38 that is configured to support the toddler in a standing position, with the toddler facing forward, i.e., facing away from the child caregiver. The standing platform 38 is attached to the stroller frame and extends between the first and second rear legs 18. The standing platform 38 is positioned below the rearwardly facing seat 28, and at least a portion of the standing platform 38 is positioned rearwardly of the rearwardly facing seat 28. The standing platform 38 serves as a footrest when the child is seated in the rearwardly facing seat 28. The standing platform 38 is also configured to support the second child in a standing position, with the second child facing in a forward direction.

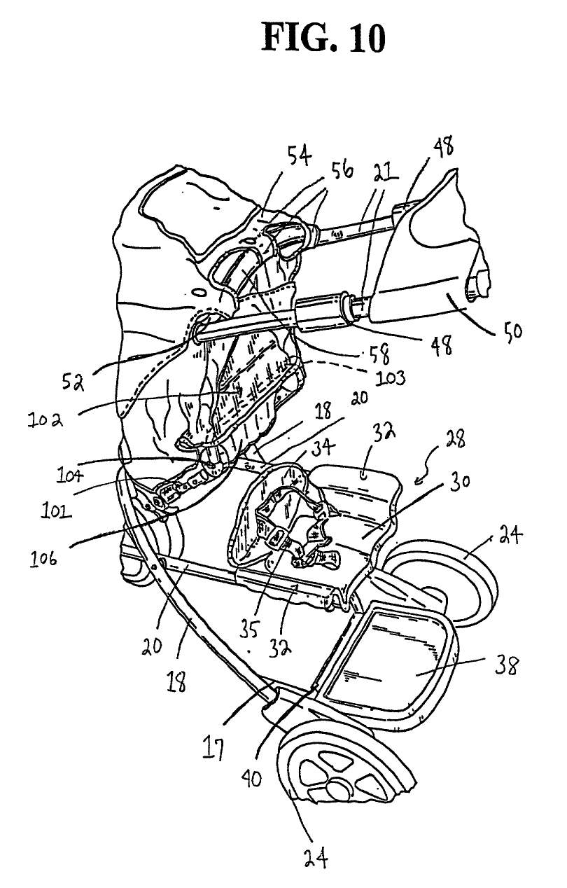

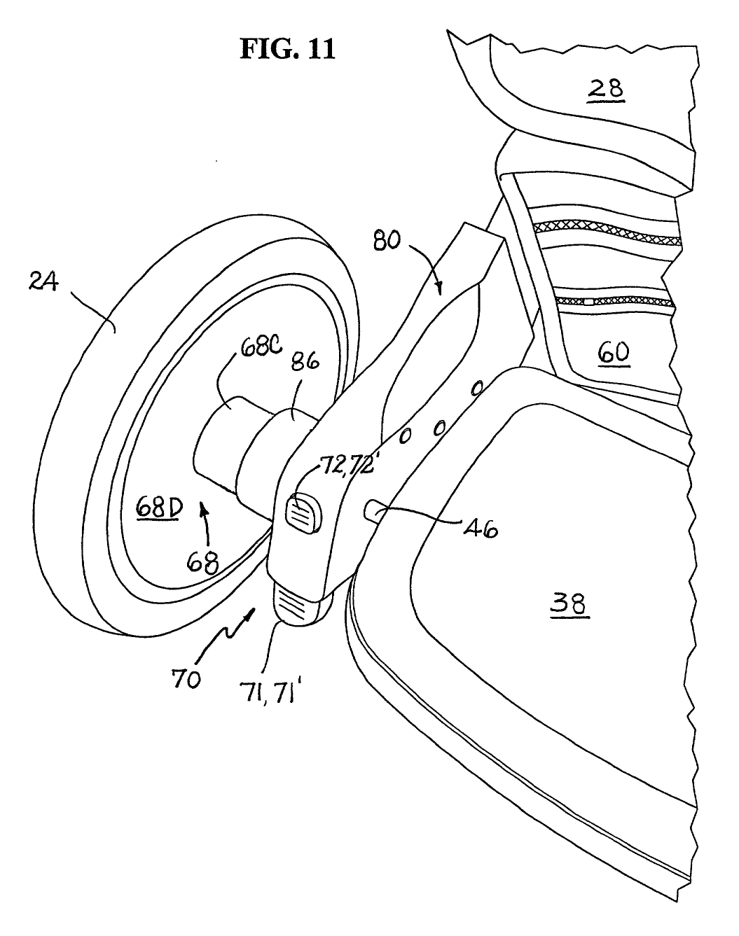

The standing platform 38 has a first edge 38a, a second edge 38b, and a neck portion 40 located at the first edge 38a. The neck portion 40 is most clearly shown in FIGS. 4 and 10. As shown in FIG. 4, the underside of the neck portion 40 includes ribs 44 having generally U-shaped grooves that receive the rear cross member 17. Once the rear cross member 17 is in place, a mounting bracket 41, as shown in FIG. 4A, can be attached to the neck portion 40 via screws. The screws are threaded through apertures 41a in the mounting bracket 41 and into corresponding apertures 40a in the neck portion. In this manner, the neck portion 40 is pivotally mounted to the rear cross member 17 such that the standing platform 38 can pivot between a first lowered position (see, for example, FIGS. 1 and 10) and a second upright position (see FIG. 5). Also shown in FIG. 5 is a rear wheel axle 46 upon which the standing platform 38 rests when in the lowered position. This rear wheel axle 46 does not rotate with the stroller wheels. Rather, the wheels rotate around the rear wheel axle 46. When pivoted upward, the standing platform 38 provides increased walking clearance for the child caregiver. The underside of the standing platform also includes an arrangement of reinforcing ribs to provide additional structural integrity to the standing platform 38 (shown in FIG. 4, but not labeled).

The tandem stroller 10 further includes a handle 22 mounted over the gripping portion 19 of the push bar, as shown in FIGS. 1 and 9. The gripping portion 19, and hence handle 22, of the push bar is adjustable to accommodate the gait of the child caregiver. Specifically, the distance between the handle 22 and the rear of the tandem stroller 10 can be increased by loosening handle locks 48 provided on push bar legs 21 and pulling rearwardly on the handle 22. This exposes a greater length of the push bar legs 21 in the area between the handle locks 48 and the forward carriage portion 12. Once the push bar legs 21 are extended to a desired length, the handle locks 48 then are tightened to lock the push bar legs 21 at the desired length. The handle locks 48 thus allow for positional adjustment of the handle 22 with respect to the push bar legs 21 so that individuals with a longer gait can walk behind the stroller without inadvertently kicking the standing platform 38 or rear wheels 24. In addition, the push bar legs 21 are lengthened a sufficient distance to provide enough space for the toddler's upper body between the handle 22 and the seat back of the forward carriage portion 12. Handle locks suitable for use in the present invention are disclosed in commonly owned, co-pending application Ser. No. 09/178,461, filed Oct. 23, 1998, and incorporated herein by reference in its entirety. A cup tray 50 can be provided adjacent the handle 22 for the convenience of the child caregiver.

As mentioned above, the stroller frame includes a push bar cross member 52 extending between the push bar legs 21, as shown in FIG. 1. A canopy 54 of the forward carriage portion 12 is mounted to the push bar cross member 52 by straps 56. The cross member 52 is exposed between the straps 56 so that, when the toddler is standing on the standing platform 38, the toddler can grip the exposed portions of the cross member 52 for balance. In prior strollers, the fabric of the canopy completely covered the push bar cross member. A cushioning material or cushioning bar 58 preferably encircles the push bar cross member 52 so that the push bar cross member 52 is soft and somewhat pliable, providing a comfortable grip area for the toddler.

In yet another aspect of the invention, the tandem stroller can include an awning (not shown) joined to the rear of the canopy 54 of the forward carriage portion 12. When not in use, the awning remains rolled up, or alternatively dangles down, behind the canopy 54. When in use, the awning releasably attaches via straps to the push bar legs 20 at a position below the handle locks 48 and extends over the rearwardly facing seat 28. When the awning is extended, a toddler sitting in the rearwardly facing seat 28 is shielded from the sun and protected from the rain.

The tandem stroller 10 of the present invention is also designed to provide ample storage space. In this connection, and with reference to FIGS. 1 and 2, the tandem stroller 10 preferably includes a first storage compartment, such as storage basket 36, removably fastened to the side support members 18 below the forward carriage portion 12 and a second storage compartment 60, such as a tote bag. The tote bag 60 removably fastens to the lower surface 62 of the toddler seat 28 and, in some embodiments, also fastens to the rear surface 64 of the first storage compartment 36. The tote bag 60 can be fastened to the seat 28 and storage basket 38 by a zipper arrangement, snaps, or hook and loop fasteners, or any other suitable fastener. The tote bag 60 can be canvas, can be insulated, and can have exterior pockets openable via a zipper, snaps, hook and loop fasteners, or any other suitable fastener. A child caregiver can store items such as diapers, bottles, books, and other infant and toddler accessories in the tote bag 60, and, when additional storage space is not needed, the tote bag 60 can be removed from the stroller 10.

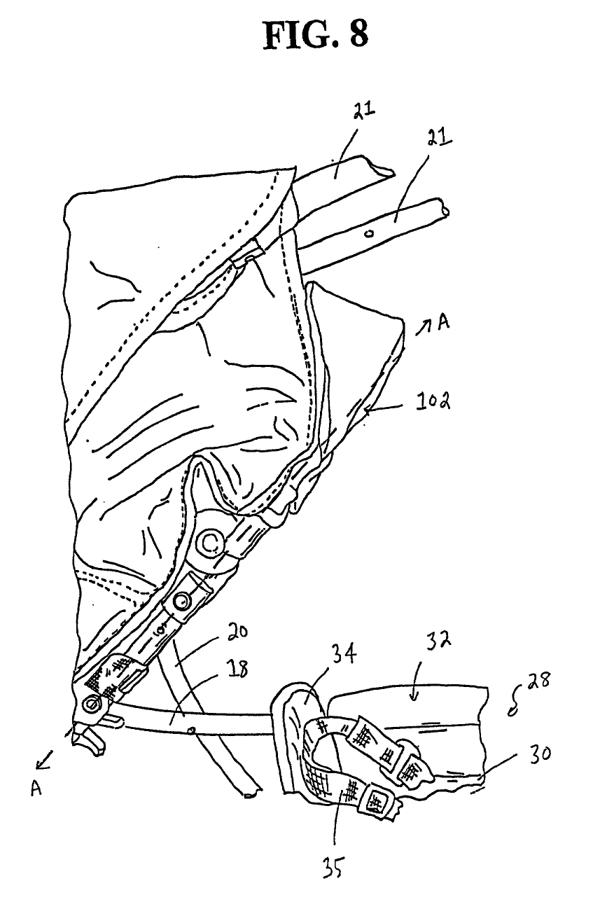

In yet another aspect of the invention, the forward carriage portion 12 of the tandem stroller 10 includes a seat back 106 having an upper portion 102 that can be adjusted to provide clearance for a second child seated on the rearwardly facing seat 28. More specifically, the seat back 106, which is mounted to the seat back frame member 25 of FIG. 1A, can be positioned in a reclined position, a middle position, or an elevated position. At any one of these positions, an upper portion 102 of the seat back 106 can be adjusted between a first position, shown in FIG. 8, and a second, substantially upright position, shown in FIGS. 9 and 10. The second, substantially upright position provides head room for the second child seated in the rearwardly facing seat 28, and, due to the pivotability of the upper portion 102 of the seat back 106, this head room is available regardless of whether the seat back 106 is in the reclined position, the middle position, or the elevated position. The seat back 106 thus does not have to be positioned in the elevated position in order for the second child to sit comfortably in the back of the tandem stroller.

FIG. 7 shows the seat back frame member 25. The seat back frame member 25 generally includes first and second seat back legs 101 and a seat back cross member 103. The seat back cross member 103 is pivotally connected to the first and second seat back legs 101 via first and second pivot assemblies 104. The pivot assemblies preferably include a button 104a, a first part 104b adapted to receive an end of a seat back leg 101, and a second part 104b adapted to receive an end of the seat back cross member 103. When the button 104a is actuated, the second part 104c is pivotable relative to the first part 104b. In this manner, the seat back cross member 103 is pivotable relative to seat back legs 101. The pivot assembly 104 can be any known lockable pivot mechanism, e.g., that found in GRACO's stroller model no. 6989XX, parts PC-24728, PD-24726, and PB21636.

The upper portion 102 of the seat back 106 is mounted to the seat back cross member 103 and is generally semicircular in shape. FIG. 2 shows a representative location of the seat back cross member 103 in the semicircular upper portion 102 of the seat back 106. The upper portion 102 of the seat back 106 preferably has a pocket into which the seat back cross member 103 can be fit. The pocket includes snaps that close the pocket around the seat back cross member 103.

The first and second seat back legs 101 are pivotally attached to the respective side support members 18, as shown in FIG. 1A. The seat back legs 101 are used to position the seat back 106 of the forward carriage portion 12 in one of the reclined position, the middle position, and the elevated position. FIGS. 2 and 2A schematically illustrate a locking mechanism suitable for use in the tandem stroller to move the seat back 106 between the three positions. The locking mechanism is shown only on the left-hand side of the tandem stroller in FIG. 2, but it will be understood that a locking mechanism would also be located at the right-hand side of the stroller. The locking mechanism, generally indicated 130, includes a locking block 132 that is mounted to the rear leg 20 at a location where the respective seat back leg passes the rear leg 20. The locking block 132 includes at least two grooves 136a, 136b. The locking mechanism 120 also includes a locking lever or tab 134 that is attached to the seat back leg 101. A tab extension 134a mounted to the locking lever 134 extends from the locking lever 134 toward the locking block 132. The tab extension 136 is biased for engagement in the grooves 136a, 136b and is shown in FIG. 2A engaged in a lower groove 136b. When the tab extension 134a is engaged in upper groove 136a, the seat back 106 is held in the upright position. When the tab extension 134a is engaged in lower groove 136b, the seat back 106 is held in the middle position. When the tab extension 134a is not engaged in a groove, the seat back 106 rests in the reclined position. The tab extension 134a can be moved between the grooves 136a, 136b by pushing the locking lever 134 toward the center of the tandem stroller (in FIG. 2A, toward the right).

Once the seat back 106 is located in the desired position, the seat back cross member 103, and hence upper portion 102 of the seat back 106, can be moved between the first position and the second, substantially upright position from any of the reclined, middle, and elevated positions. As shown in FIG. 8, when the seat back cross member 103 is in the first position, the seat back legs 101 and the seat back cross member 103 lie along substantially the same axis A-A. In the second, substantially upright position shown in FIG. 9, the seat back cross member 103 is oriented at an angle relative to the seat back legs 101.

To pivot the seat back upper portion 102 between the first position and the second, substantially upright position, the child caregiver can actuate the button 104a of the pivot assembly 104 which releases the seat back cross member 103 from a locked position relative to the seat back legs 101. The child caregiver can then manually move the seat back cross member 103 to the desired position and release the button 104a. In an alternative embodiment, a pair of pivot legs can replace the seat back cross member 103, one extending from each pivot assembly 104. The pivot legs of this alternative embodiment extend at least partially into a respective side of the upper portion 102 of the seat back 106. These pivot legs can pivot in the same manner as the seat back cross member 103 to move the upper portion 102 of the seat back 106 between the first position and the second, substantially upright position.

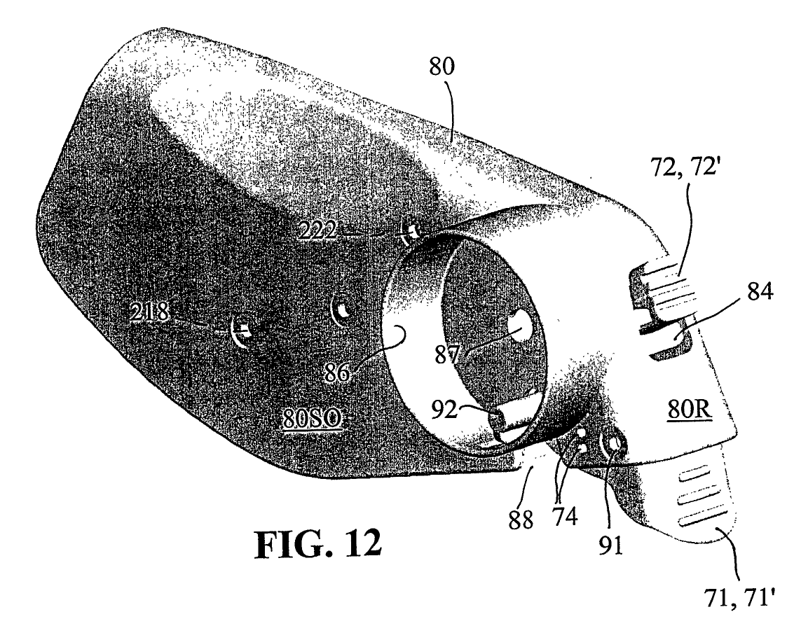

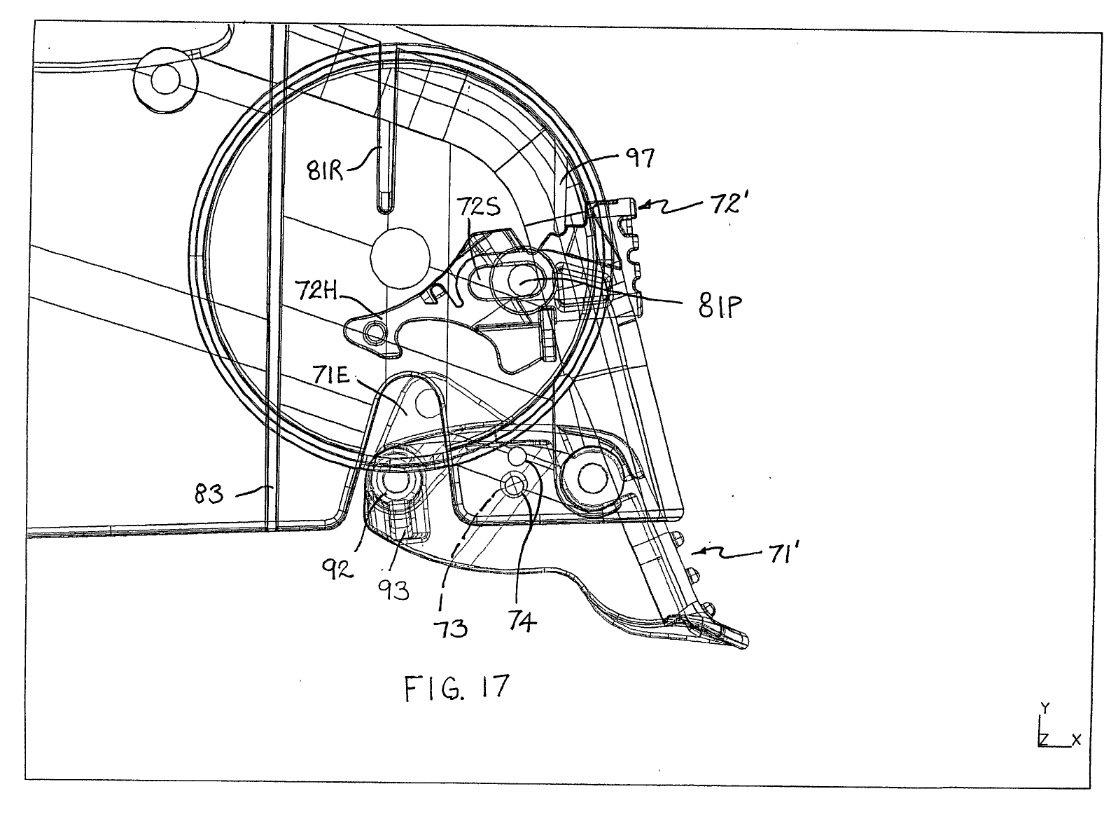

FIGS. 11-16C schematically illustrate a brake mechanism 70 that can be used in the present tandem stroller 10. Each brake mechanism 70 includes brake lever 71, 71′ and a brake safety member 72, 72′ supported in a housing 80. The brake lever 71, 71′ is movable between a brake engagement position (FIGS. 12, 15, 16) and a brake disengagement position (FIG. 17). The safety member 72, 72′, e.g., safety lock button or switch, is movable between an ON or lock position (FIGS. 12, 15, 16) in which the brake lever 71, 71′ is locked in the brake engagement position and an OFF or unlock position (FIG. 17) in which the brake lever 71, 71′ can move between the brake engagement and disengagement positions. The safety member 72, 72′ thus can enable and disable the brake lever operation.

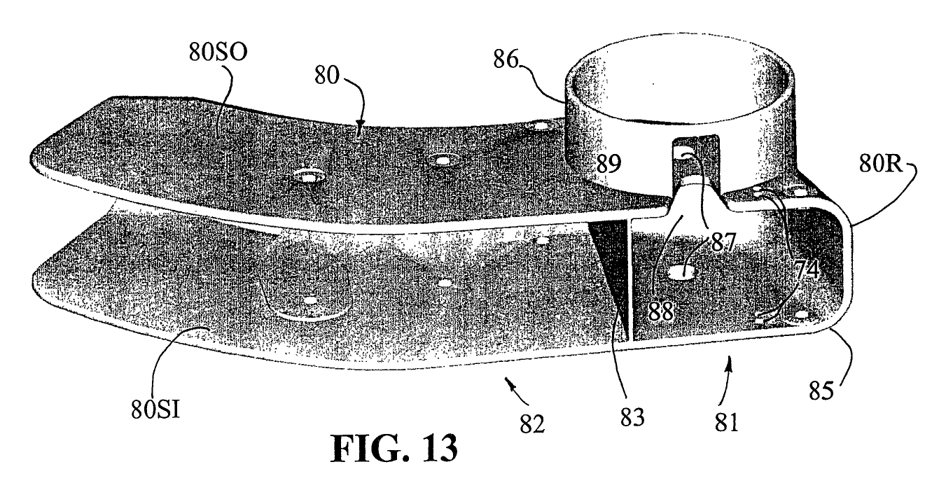

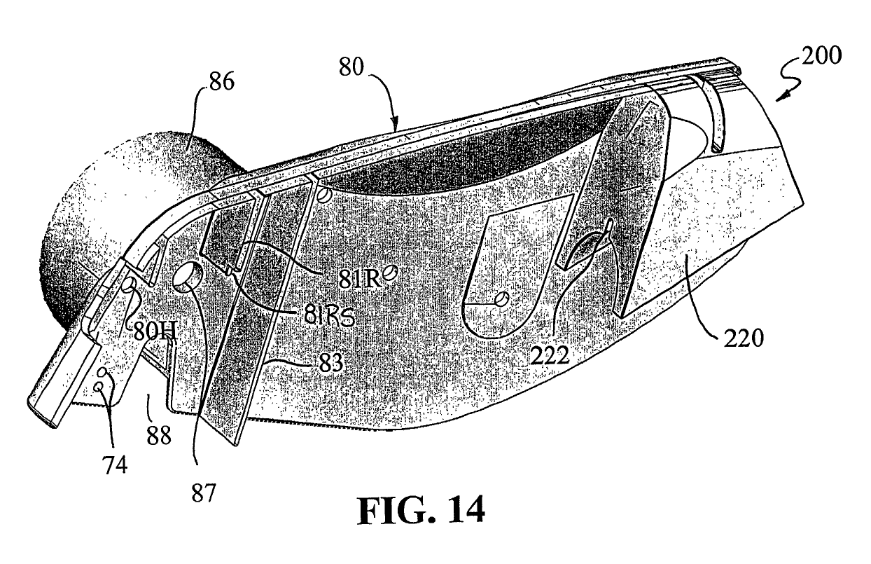

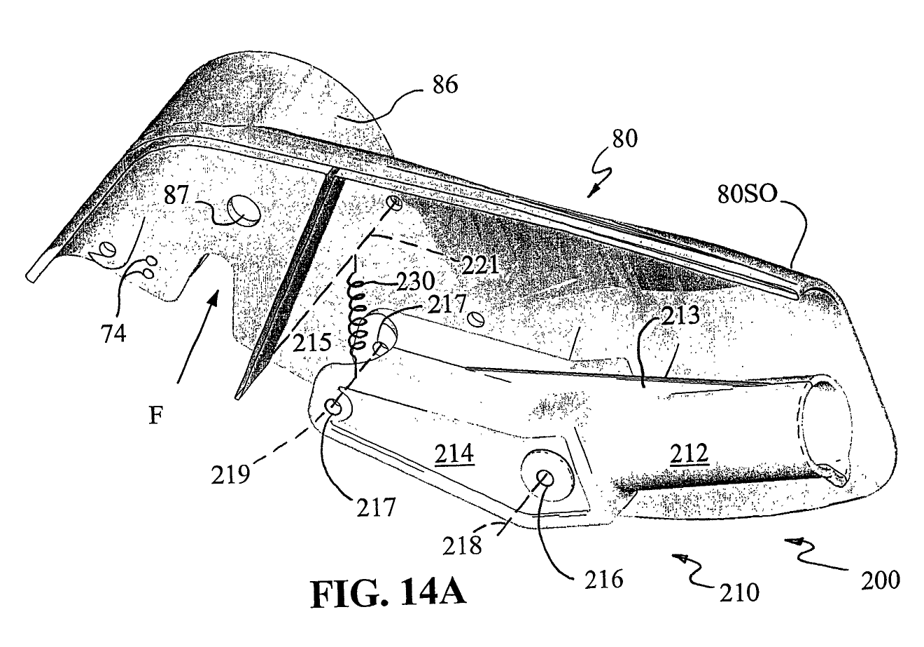

Referring to FIGS. 11-14A, the housing 80 has a first compartment 81 configured to receive and pivotally support the brake lever 71, 71′ and to receive and movably support the safety member 72, 72′. The housing 80 also has a second compartment 82 configured to suspendedly support the respective rear leg 20b. See FIGS. 14 and 14A. A partition wall 83 can separate the first and second compartments 81, 82. The first housing compartment 81 has an aperture 84 through its rear wall 80R and an open bottom 85. A portion of the safety member 72, 72′ can extend outwardly through the aperture 84 and a portion of the brake lever 71, 71′ can extend below the housing through the open bottom 85 as more clearly illustrated in FIGS. 12 and 13.

Referring to FIGS. 12-14A, the brake housing 80 has a generally cylindrical portion 86 extending outwardly from its outer side wall 80SO. An axle through hole 87 is formed through each of the outer and inner side walls 80SO, 80SI of the housing 80 (through the first compartment 81). The axle through holes 87 are axially aligned and extend collinearly with the cylindrical portion 86. The rear wheel axle 46 extends through the axle through holes 87 so that each axle end can be attached to the respective rear wheel 24. To enable the brake lever 71, 71′ to move between the engaged and disengaged positions, the housing outer side wall 80SO and the cylindrical portion 86 crossing the path of the wheel engaging member 92 have cutouts 88 and 89, respectively, as shown in FIGS. 12-14A. The cutout 88 extends upwardly from the open bottom 84, in the first compartment 81, where the brake lever 71, 71′ is positioned. The wheel engaging member 92 and the flange 93 (see below) extend laterally through the cutouts 88 and 89 to engage the brake sprocket of the rear wheel 24.

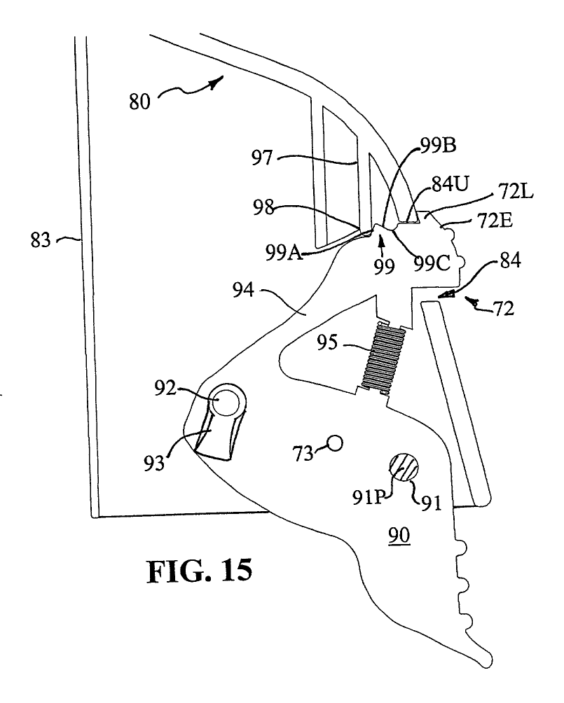

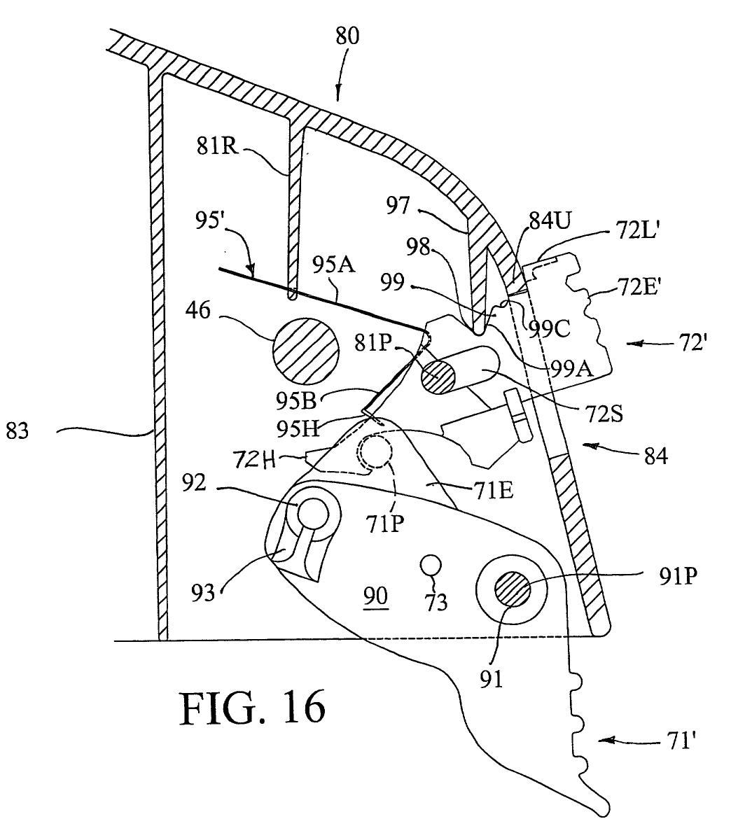

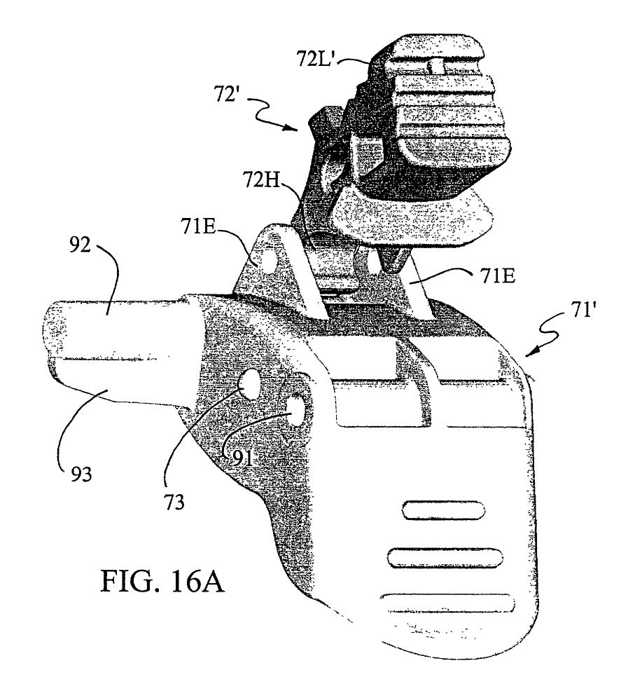

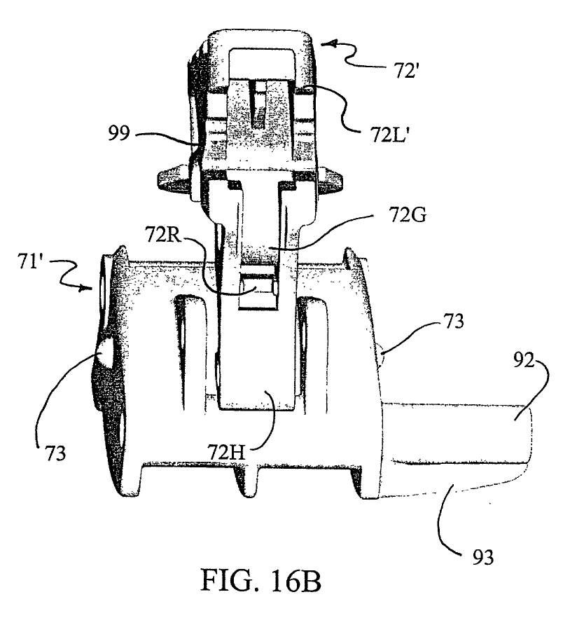

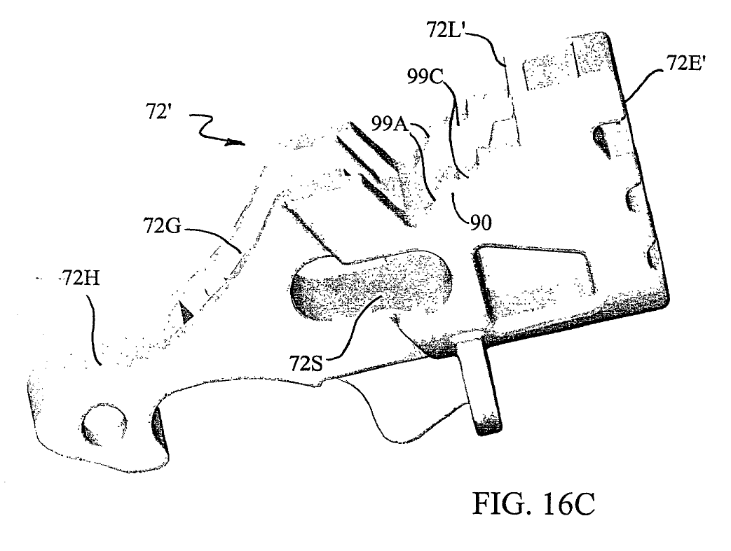

To enhance positive positioning of the brake lever 71, 71′, the brake lever 71, 71′ can have at least one protrusion 73 (see FIGS. 15-16B) that cooperates with a pair of complementary engaging surfaces 74 (see FIGS. 12-14A) corresponding to the brake enabled and disengaged positions, formed in at least one of the housing side walls 80SO, 80SI. The protrusion 73 and complementary engaging surfaces 74 can be reversibly positioned if desired. That is, the protrusion 73 can be formed on the housing side wall 80SO, 80SI and the complementary engaging surfaces 74 can be formed on the brake lever 71, 71′. The protrusion 73 can be a round bump formed on the side of the brake lever 71. The engaging surfaces 74 each can be a hole formed through the housing side wall 80SO, 80SI and sized to positively position the lever 71, 71′ to either the disengaged or engaged position. Although only one bump 73 is needed, a bump 73 can be placed on each side of the brake lever 71 and a pair of openings 74 can be placed on each housing side wall 80SO, 80SI, opposite one another to enable even a better positive positioning of the brake lever 71, 71′ as shown in FIGS. 13 and 16B.

FIG. 15 shows an embodiment of a brake mechanism where the brake lever 71 can be made integral with the safety member 72, i.e., one-piece or monolithic construction. FIGS. 16-16C show another embodiment where the brake lever 71′ and the safety member 72′ are separate and discrete elements.

Referring to the embodiment of FIG. 15, the brake lever 71 comprises a body 90 having an aperture 91, which acts as a pivot axis, a wheel engaging member 92 extending outwardly substantially parallel to the pivot axis, and a connecting portion 94 bridging the brake lever 71 to the safety member 72. The connecting portion 94 is resilient (i.e., acts as a spring-like cantilever) to permit the safety member 72 to move relative to the brake lever 71. A spring 95 is positioned to bias the safety member 72 away from the brake lever 71 (to the position illustrated in FIG. 15). The brake lever 71 can be pivotally mounted to the housing 80 using a conventional pin, shaft, rivet or the like 91P extending through the aperture 91. The wheel engaging member 92 is movable toward and away from a brake sprocket (not shown), which extends coaxially with the wheel axle 46. The wheel engaging member 92 can have a rib 93 to strengthen or stiffen the same.

The safety member 72 cooperates with the housing to keep the brake lever 71 from pivoting to the brake disengaged position when the safety member is in the ON position, where a portion of the safety member extends OUT through the housing aperture 84. The safety member 72 has a finger or foot engaging surface 72E at its proximal end and a lip 72L adjacent the engaging surface 72E. The lip 72L cooperates with an upper edge 84U of the aperture 84 to maintain the safety member 72 in the ON, i.e., OUT, position. Pivoting the brake lever 71 to the brake engage position (FIG. 15) causes the lip 72L to move through the aperture 84. Because the connecting member 94 is resilient, the safety member 72 will be forced downwardly so that the lip 72L can move through the aperture 94. Since the spring 95 urges the safety member 72 away, i.e., upwardly, from the brake lever 71, once the lip 72L passes through the aperture 84, the safety member 72 moves upwardly. The lip 72L catches the upper edge 84U of the aperture 84, upon which the lip 72L abuts against the same to keep the safety member 72 in the OUT position. When one attempts to move the brake lever 71 toward the brake disengaged position, since the lip 72L is caught by the aperture upper edge 84U, the brake lever 71 is prevented from pivoting (counterclockwise direction in FIG. 15) toward the disengaged position.

An additional locking feature can be included to keep the safety member 72 in the ON or OUT position. As shown in FIG. 15, the housing 80, in the first compartment 81, has another stop 97, which can be in the form of a rib or wall or the like, extending downwardly therefrom. The end 98 of the stop 97 is adapted to engage and hold the safety member 72 in the ON position and the OFF position. In this regard, the safety member 72 has a sear 99 that engages the stop end 98. The sear 99 has a first surface 99A and a second surface 99B. The first and second sear surfaces 99A, 99B can be orthogonal to each other or form an obtuse angle. The lower end of the first sear surface 99a abuts against the stop end 98 when the safety member 72 is moved to the OUT position. Thus, both the sear 99 and the aperture upper edge 84U act to maintain the safety member 72 in the OUT position. To enable the brake lever 71 to move toward the brake disengaged position, the safety member 72 must be first lowered to clear both the first sear surface 99A and the aperture upper edge 84U.

When the safety member is pushed to the IN position, the stop end 98 can be positioned in a groove 99C formed contiguous with the second sear surface 99B. The slope between to the stop end 98 and the second sear surface 99B can be acute so that moving the brake lever 71 to the brake engaged position will cause the second sear surface 99B to slide against the stop end 98 and lower the safety member 72, enabling the lip 72L to clear the aperture 84. The second sear surface 99B thus acts as a cam or ramp to lower the safety member 72 while the safety member 72 is moved toward the OUT position. Once the stop end 98 abuts the first sear surface 99A, due to the relative steeper angle relationship with the stop end 98, the safety member 72 will slide upwardly with the help of the spring 95 and the urging of the brake lever 71 in the clockwise direction (in FIG. 8).

FIGS. 11, 12, and 15 show the brake lever 71 in the brake engaged position and the safety member 72 in the OUT position, signifying that the brake is ON and locked. By comparison, the combination of the brake lever 71 in an up (disengaged) position and the safety button 72 in the IN position signifies that the brake is disengaged. When the safety member is in the IN position, the brake lever 71 can be in either the brake engaged or disengaged position.

FIGS. 16-16C show another embodiment of the brake mechanism, where the brake lever 71′ and the safety member 72′ are discrete elements. The second embodiment functions similar to the former embodiment, in that the safety member 72′ must be pushed IN to move the brake lever 71′ to the brake disengaged position. The brake lever 71′ is similar to that of the former embodiment, but without the connecting member 94. Instead of the connecting member 94, the brake lever 71′ has a pair of spaced apart ears 71E having aligned holes 71H through which a shaft or pin 71P extends parallel to the brake lever pivot axis.

The safety member 72′ also has a lip 72L′ adjacent to its proximal end. Like the former embodiment, the lip 72L′ can engage the aperture upper edge 84U. A pin 81P extends through a pair of aligned holes 80H (see FIG. 14) formed in the housing side walls 80SO, 80SI. The safety member 72′ has a slot 72S through which the pin 81P extends. The safety member 72′ is movable between the confines of the slot 72S. An engaging member 72H is formed at the distal end of the safety member 72′. The engaging member 72H is configured to hook or latch onto the pin 71P to lock the brake lever 71′ to the brake engaged position, as shown in FIG. 16. In this respect, the engaging member 72H can be a hook, as better shown in FIG. 16C.

Referring to FIG. 16, a spring 95′ is used to bias the safety member toward the OUT position. The spring 95′ can be a leaf spring, bent at an acute angle, defining two spring legs 95A, 95B. The longer spring leg 95A abuts against a rib or wall 81R extending from the first housing compartment 81. The shorter spring leg 95B abuts against the safety member 72′. The rib 81R can have a slot or recess 81RS (see FIG. 14) dimensioned to receive and seat the longer spring leg 95A to confine the spring 95′ from moving side to side.

Referring to FIGS. 16B-16C, the safety member 72′ can include a groove or a slot 72G dimensioned to receive or seat the shorter spring leg 95A to confine the spring 95′ from moving side to side. The groove 72G can further include a recess 72R at its distal end to receive an end 95H of the shorter spring leg 95A, which can be a hook or be bent to better secure the spring 95′ to the safety member 72′.

Similar to the former embodiment, the safety member 72′ cooperates with the housing 80 to keep the brake lever 71′ from pivoting to the brake disengaged position when the safety member 72′ is in the OUT position. The safety member 72′ has a finger or foot engaging surface 72E′ at its proximal end and the lip 72L′ adjacent to the engaging surface 72E′. The lip 72L′ cooperates with the aperture upper edge 84U to maintain the safety member 72′ in the OUT position.

When the safety member 72′ is in the IN position, the proximal end portion of the slot 72U is near or abuts against the pin 81P, with the engaging member 72H disengaged from the brake lever 71′, as shown in FIG. 17. Pivoting the brake lever 71′ to the brake engaged position can move the safety member 72′ from its IN position to the OUT position. This is achieved by pushing the safety member 72′ outwardly with the brake lever 71′ so that the upper surface of the lip 72L′ clears the aperture upper edge 84U. As the safety member 72′ moves to the OUT position, the engaging member 72H can latch onto the brake lever 71′. Specifically, the engaging member 72H becomes wedged between the ears 71E and the pin 71P, which prevent the brake lever 71′ from pivoting to the brake disengaged position. The spring 95′ urges the engaging member 72H toward the brake lever 71′ to maintain the safety member 72′ stay connected to the brake lever 71′.

When the brake lever 71′ is pivoted to the brake engaged position, the pin 81P engages the distal edge of the slot 72S and the lip 72L′ abuts against the aperture upper edge 84U, as shown in FIG. 16. In this position, the spring 95′ urges the engagement portion 72H toward the brake lever 71′ to keep them latched and keep the safety member in the OUT position. The spring 95′ also biases the distal end portion (engaging member 72H) of the safety member 72′ against the pin 71P. Since the safety member 72′ is rotatable relative to the pin 81P (in the slot 72S), the safety member 72′ is biased to rotate counterclockwise (in FIG. 16), which biases the proximal end (lip 72L′) upwardly to maintain the lip 72L′ abutting against the aperture upper edge 84U.

Referring to FIG. 16, the housing 80, in the first compartment 81, has a stop 97 as in the former embodiment. The stop end 98 is adapted to engage and hold the safety member 72′ as in the former embodiment. The safety member 72′ has a sear 99 that engages the stop end 98. The sear 99 has a first surface 99A and a groove 99C, as described in the former embodiment. The stop end 98 can sits at the valley formed between the first sear surface 99A and the adjoining inclined surface.

To disengage the brake, the safety member 72′ must be lowered to clear both the first sear surface 99A and the aperture upper edge 84U, and pushed IN, against the bias of the spring 95′. Pushing IN the safety member 72′ will disengage the safety member 72′ from the brake lever 71′ so that the brake lever 71′ can rotate in counterclockwise direction (in FIG. 16) to the brake disengaged position. In the IN position, the upper surface of the lip 72L′ engages the aperture upper edge 84U and the stop end 98 is seated in the groove or recess 99C against the spring bias, where the safety member 72′ is rotated in the clockwise direction (in FIG. 17). In this position, the engaging member 72H is moved out of the way of the path of the brake lever 71′ so that the brake lever 71′ is free to rotate in the counterclockwise direction.

The safety member 72′ is held in the IN position by the spring 95′ biasing the proximal end of the safety member 72′ upwardly and the groove 99C. The groove 99C is formed contiguous with the first sear surface 99A. Moving the brake lever 71′ to the brake engaged position will cause the stop end 98 to slide out of the groove 99C and move onto the first sear surface 99A. The first sear surface 99A and the grove 99C can be configured so that moving the brake lever 71′ to the brake engaged position will slightly lower the proximal end (lip 72L′) as it moves outwardly. Once the stop end 98 abuts the first sear surface 99A, due to the relative steeper angle relationship with the stop end 98, the safety member 72′ will slide upwardly with the help of the spring 95′ and the motion of the brake lever 71′.

In operation, to engage the brake mechanism and stop the stroller from rolling, a caregiver pushes the brake lever 71,71′ toward the front of the stroller, which moves the wheel engaging member 92 to the rear wheel brake sprocket (not shown) and lock the wheel. When the brake lever 71, 71′ is moved to the engaged position, the safety member 72, 72′ pops OUT. The OUT position signifies that the brake is engaged. To release the brake mechanism, a caretaker pushes the safety member 72, 72′ IN. The brake lever 71 is designed to be released only when this safety member 72, 72′ is in the IN position. Pushing IN the safety member 72, 72′ allows the brake lever 71 to be pulled away from the front wheel to return the brake lever 71, 71′ to the disengaged position. Because two separate structural elements, namely, the safety member 72, 72′ and the brake lever 71, 71′, must be individually and sequentially actuated to release the brake, the likelihood that a toddler would accidentally release the brake is reduced.

FIG. 11 shows the safety features that can be incorporated in the present tandem stroller 10. To ensure that the toddler's feet, fingers, and clothes do not accidentally become entangled with the rear wheels 24, the wheel suspension assembly 200 and the brake mechanism 70, the stroller 10 can include a stationary shield 68, configured to cover the inner side of the wheel 24, and use the brake housing 80 to house the suspension assembly 200.

Referring to FIG. 11, the shield 68 includes a circular disk 68D sized to cover the inner side of the wheel 24 with a close tolerance (a small gap) and a cylindrical member 68C extending collinearly therefrom. The cylindrical member 68C shrouds the brake sprocket and is collinearly or coaxially aligned with the housing cylindrical portion 86. The cylindrical member 68C is aligned with and nonmovably connected to the housing cylindrical portion 86. The shield is thus stationary with respect to the housing 80 to minimize the exposure of moving parts.

FIGS. 14 and 14A illustrate a wheel suspension assembly 200, positioned in the second compartment 82 of the housing 80. The wheel suspension assembly 200 comprises an elongated body 210 having a tubular member 212 and a pivot member 214 extending from the tubular member 212. The tubular member 212 is adapted to receive and hold a rear leg 20b. In this respect, any conventional tube fastening means, such as tabs, rivets, pins, etc., can be used to maintain the rear leg 20b connected to the tubular member 212. The pivot member 214 has a pivot hole 216 through which a pivot pin or rod 218 extends. The pivot pin 218 is secured to the housing side walls 80SO, 80SI to enable the elongated body 210 to pivot. The wheel suspension assembly 200 further includes an elastic bushing 220 positioned in the distal end portion of the housing 80. The elastic bushing 220 is configured complementary to the tubular member 212 so that it can receive the tubular member 212. In this regard, the bushing 220 has a slot 222 that engages a rib 213 formed on the tubular member 212 to maintain the bushing 220 aligned and connected to the tubular member 212. When a force F is applied through the wheel axle 46, the tubular member 212 can pivot in the counterclockwise direction (in FIG. 14A) so that the tubular member 212 compresses against the elastic bushing 220 to absorb shock.

The distal end of the pivot member 214 has a pair of ears 215 with aligned holes 217, through which a shaft or axle 219 extends. A shaft 221 is attached to the housing side walls 80SO, 80SI. A spring 230 is attached to the shaft 219 and the shaft 221 to return the elongated body 210 to its neutral position.

In describing the invention, reference has been made to a preferred embodiment and illustrative advantages of the invention. Those skilled in the art, however, and familiar with the instant disclosure of the subject invention, may recognize that numerous other modifications, variations, and adaptations may be made without departing from the scope of the invention as defined in the claims.

We claim:

1. A tandem stroller comprising:
a stroller frame including
first and second front legs, each having a first end attached to a respective front wheel, first and second rear legs, each having a first end attached to a respective rear wheel and a second end pivotally attached to a second end of said respective first and second front legs,
a push bar having a gripping portion and first and second push bar legs extending from said gripping portion, said first and second push bar legs pivotally attaching to said first and second rear legs, respectively, and
first and second side support members each having a first end and a second end, said first side support member pivotally attached to said first front leg and said first rear leg, said second side support member pivotally attached to said second front leg and said second rear leg;
a forward carriage portion attached to said stroller frame and adapted to carry a first child; and
a rearwardly facing seat attached to said first and second side support members at a location rearward of said first and second rear legs, said rearwardly facing seat adapted for a second child to sit behind said forward carriage portion and to face in a rearward direction.

2. The tandem stroller according to claim 1, wherein said rearwardly facing seat extends over said second ends of said first and second side support members.

3. The tandem stroller according to claim 1, wherein said rearwardly facing seat includes a seat base and a flexible seat back.

4. The tandem stroller according to claim 3, wherein said seat base includes a first edge and a second edge, and said flexible seat back is attached to said second edge of said seat base.

5. The tandem stroller according to claim 1, wherein said rearwardly facing seat includes a seat base having side bolsters.

6. The tandem stroller according to claim 1, further comprising a belt restraint system attached to said rearwardly facing seat, said belt restraint system adapted to hold the second child in said rearwardly facing seat.

7. The tandem stroller according to claim 1, wherein said rearwardly facing seat includes a contoured seat base.

8. The tandem stroller according to claim 1, further comprising a standing platform attached to said stroller frame and extending between said first and second rear legs, said standing platform being positioned below said rearwardly facing seat, and at least a portion of said standing platform being positioned rearwardly of said rearwardly facing seat.

9. The tandem stroller according to claim 8, wherein said stroller frame further includes a rear cross member extending between said first and second rear legs, and said standing platform is mounted to said rear cross member.

10. The tandem stroller according to claim 9, wherein said standing platform pivots about said rear cross member.

11. The tandem stroller according to claim 9, wherein said standing platform includes a first edge, a second edge, and a neck on said first edge, said first edge being pivotally mounted to said rear cross member via said neck such that said standing platform pivots on said rear cross member between a first lowered position and a second upright position.

12. The tandem stroller according to claim 11, wherein said stroller frame further includes a rear wheel axle extending between said rear wheels, and said standing platform rests on said rear wheel axle when said standing platform is in the first lowered position.

13. The tandem stroller according to claim 1, wherein said stroller frame further includes a push bar cross member extending between said first and second push bar legs.

14. The tandem stroller according to claim 13, wherein said forward carriage portion includes a canopy mounted to said push bar cross member by straps such that at least a portion of said push bar cross member is exposed between said straps.

15. The tandem stroller according to claim 14, further comprising cushioning disposed around said exposed portion of said push bar cross member.

16. The tandem stroller according to claim 8, wherein said stroller frame further includes a push bar cross member extending between said first and second push bar legs.

17. The tandem stroller according to claim 16, wherein said forward carriage portion includes a canopy mounted to said push bar cross member by straps such that at least a portion of said push bar cross member is exposed between said straps.

18. The tandem stroller according to claim 16, further comprising cushioning disposed around said exposed portion of said push bar cross member.

19. The tandem stroller according to claim 17, further comprising an awning joined to said canopy and releasably attachable to said first and second push bar legs to extend over said rearwardly facing seat.

20. The tandem stroller according to claim 1, further comprising a first storage compartment removably fastened to said stroller frame and located below said forward carriage portion.

21. The tandem stroller according to claim 20, wherein said first storage compartment is removably fastened to said first and second side support members.

22. The tandem stroller according to claim 21, further comprising a second storage compartment removably fastened to a lower surface of said rearwardly facing seat.

23. The tandem stroller according to claim 22, wherein the second storage compartment is removably fastened to a rear surface of said first storage compartment.

24. The tandem stroller according to claim 1, wherein said forward carriage portion includes a seat back, and said stroller frame further includes a seat back frame member connected to said first and second side support members, said seat back frame member having first and second seat back legs and a seat back cross member pivotally connected to said first and second legs via a pivot assembly, said seat back of said forward carriage portion being mounted to said seat back cross member, said pivot assembly adapted to pivot said seat back cross member from a first position to a second, substantially upright position.

25. A tandem stroller according to claim 1, further comprising a brake mechanism for each rear wheel, said brake mechanism including
a brake housing adapted to connect to said stroller frame;
a brake lever pivotally mounted to said brake housing and movable between a brake engaged position and a brake disengaged position, said brake lever having a brake sprocket engaging member adapted to engage a brake sprocket of said respective rear wheel;
a brake safety member mounted to said housing and movable between an ON position and an OFF position, wherein said brake safety member operatively engages said brake lever to lock said brake lever from moving toward the brake disengaged position when said brake safety member is in the ON position, and allowing said brake lever to move to the brake disengaged position when said brake safety member is in the OFF position.

26. A tandem stroller comprising:
a stroller frame;
a forward carriage portion attached to said stroller frame and adapted to carry a first child; and
a rearwardly facing seat attached to said stroller frame and adapted to permit a second child to sit behind said forward carriage portion, with the second child facing in a rearward direction, said rearwardly facing seat being structurally independent of said forward carriage portion.

27. The tandem stroller according to claim 26, wherein said rearwardly facing seat is rigidly fastened to said stroller frame.

28. The tandem stroller according to claim 26, wherein said rearwardly facing seat includes a seat base and a flexible seat back.

29. The tandem stroller according to claim 28, wherein said seat base includes a first edge and a second edge, and said flexible seat back is attached to said second edge of said seat base.

30. The tandem stroller according to claim 26, wherein said rearwardly facing seat includes a seat base having side bolsters.

31. The tandem stroller according to claim 26, further comprising a belt restraint system attached to said rearwardly facing seat, said belt restraint system adapted to hold the second child in said rearwardly facing seat.

32. The tandem stroller according to claim 26, wherein said rearwardly facing seat includes a contoured seat base.

33. The tandem stroller according to claim 26, further comprising a standing platform attached to said stroller frame and extending between said first and second rear legs, said standing platform being positioned below said rearwardly facing seat, and at least a portion of said standing platform being positioned rearwardly of said rearwardly facing seat.

34. The tandem stroller according to claim 26, further comprising a first storage compartment removably fastened to said first and second side support members and located below said forward carriage portion, and a second storage compartment removably fastened to a lower surface of said rearwardly facing seat.

35. The tandem stroller according to claim 34, wherein the second storage compartment is removably fastened to a rear surface of said first storage compartment.

36. A tandem stroller comprising:
a stroller frame;
a forward carriage portion attached to the frame and adapted to carry a first child;
a rearwardly facing seat attached to said stroller frame to permit a second child to sit behind said forward carriage portion, with the second child facing a rearward direction, said rearwardly facing seat having a rigid seat portion and a flexible seat back structurally independent of said forward carriage portion; and
a storage compartment mounted to said stroller frame at a position below said forward carriage portion, said flexible seat back of said rearwardly facing seat being moveable in a direction toward said rigid seat portion to allow access to said storage compartment.

37. The tandem stroller according to claim 36,-wherein said flexible seat back includes a child restraint system mounted to a front face thereof to hold the second child in said rearwardly facing seat.

38. The tandem stroller according to claim 36, wherein said rigid seat portion includes a contoured base and side bolsters on each side of said contoured base.

39. A tandem stroller comprising:
a stroller frame including
first and second front legs, each having a first end attached to a respective front wheel,
first and second rear legs, each having a first end attached to a respective rear wheel and a second end pivotally attached to a second end of said respective first and second front legs,
a push bar having a gripping portion and first and second push bar legs extending from said gripping portion, said first and second push bar legs pivotally attaching to said first and second rear legs, respectively,
first and second side support members each having a first end and a second end, said first side support member pivotally attached to said first front leg and said first rear leg, said second side support member pivotally attached to said second front leg and said second rear leg, and
a push bar cross member extending between said first and second push bar legs;
a forward carriage portion attached to said stroller frame and adapted to carry a first child, said forward carriage portion including a canopy releasably attached to said push bar cross member such that at least a portion of said push bar cross member is exposed; and
a standing platform attached to said stroller frame between said first and second rear legs.

40. The tandem stroller according to claim 39, wherein said canopy is releasably attached to said push bar cross member by straps.

41. The tandem stroller according to claim 39, further comprising cushioning disposed around said exposed portion of said push bar cross member.

42. A tandem stroller comprising:
a stroller frame including first and second rear legs that terminate at respective rear wheels and a rear cross member extending between said first and second rear legs;
a forward carriage portion attached to said stroller frame and adapted to carry a first child; and
a standing platform having a first edge, a second edge, and a neck on said first edge, said neck being pivotally attached to said rear cross member such that said standing platform pivots on said rear cross member between a first lowered position and a second upright position.

43. The tandem stroller according to claim 42, wherein said stroller frame further includes a rear wheel axle extending between said rear wheels, and said standing platform rests on said rear wheel axle when said standing platform is in the first lowered position.

44. A tandem stroller comprising:
a stroller frame;
a forward carriage portion attached to said stroller frame and adapted to carry a first child;
a rearwardly facing seat attached to said stroller frame to permit a second child to sit behind said forward carriage portion, with the second child facing a rearward direction;
a first storage compartment removably attached to said stroller frame and positioned below said forward carriage portion; and
a second storage compartment removably attached to a lower surface of said rearwardly facing seat.

45. The tandem stroller according to claim 44, wherein said second storage compartment is removably attached to a rear surface of said first storage compartment.

46. The tandem stroller according to claim 44, wherein said stroller frame includes first and second front legs, first and second rear legs, a push bar having a gripping portion and first and second push bar legs pivotally attaching to said first and second rear legs, respectively, and first and second side support members pivotally attached to said respective front leg and said respective rear leg, and said first storage compartment is removably fastened to said first and second side support members.

47. A stroller comprising:
a stroller frame including
first and second front legs, each having a first end attached to a respective front wheel,
first and second rear legs, each having a first end attached to a respective rear wheel and a second end pivotally attached to a second end of said respective first and second front legs,
a push bar having a gripping portion and first and second push bar legs extending from said gripping portion, said first and second push bar legs pivotally attaching to said first and second rear legs, respectively,
first and second side support members each having a first end and a second end, said first side support member pivotally attached to said first front leg and said first rear leg, said second side support member pivotally attached to said second front leg and said second rear leg, and
a seat back frame member connected to said first and second side support members, said seat back frame member having first and second seat back legs and a seat back cross member pivotally connected to said first and second seat back legs via first and second pivot assemblies, respectively;
a forward carriage portion including a seat back, said seat back being mounted to said seat back cross member, said pivot assembly adapted to pivot said seat back cross member relative to said first and second seat back legs from a first position to a second, substantially upright position; and
a rearwardly facing seat attached to said first and second side support members to permit a second child to sit behind said forward carriage portion, with the second child facing a rearward direction.

48. The tandem stroller according to claim 47, wherein said seat back cross member and said first and second seat back legs each include a first end and a second end, said first end of said first seat back leg being connected to said first side support member and said second end of said first seat back leg being connected to said first pivot assembly, said first end of said second seat back leg being connected to said second side support member and said second end of said second seat back leg being connected to said second pivot assembly, and said first end of said seat back cross member being connected to said first pivot assembly and said second end of said seat back cross member being connection to said second pivot assembly.

49. A brake mechanism for a stroller comprising:
a brake housing adapted to connect to a stroller frame;
a brake lever pivotally mounted to said brake housing and movable between a brake engaged position and a brake disengaged position, said brake lever having a brake sprocket engaging member adapted to engage a brake sprocket of a stroller wheel;
a brake safety member mounted to said housing and movable between an ON position and an OFF position, wherein said brake safety member operatively engages said brake lever to lock said brake lever from moving toward the brake disengaged position when said brake safety member is in the ON position, and allowing said brake lever to move to the brake disengaged position when said brake safety member is in the OFF position.

50. A brake mechanism according to claim 49, wherein said brake lever operatively engages said brake safety member to move said brake safety member to the ON position when said brake lever is moved to the brake engaged position.

51. A brake mechanism according to claim 50, wherein said brake lever and said brake safety member are discrete elements, and said brake safety member is pivotally and movably mounted to said housing.

52. A brake mechanism according to claim 51, wherein said brake safety member has an elongated slot and an engaging member that latches onto said brake lever to prevent said brake lever from moving to the brake disengaged position when said brake safety member is in the ON position.

53. A brake mechanism according to claim 52, wherein said housing includes an aperture and said brake safety member has a portion that protrudes through the aperture and maintains said brake safety member in the ON position.

54. A brake mechanism according to claim 53, further including a spring that biases said brake safety member toward the ON position.

55. A brake mechanism according to claim 54, wherein said housing further includes a stop that engages said brake safety member when said brake safety member is in the ON position to maintain said brake safety member in the ON position and in the OFF position to maintain said brake safety member in the OFF position.

56. A brake mechanism according to claim 55, wherein said portion of said brake safety member is a lip, and said brake safety member further includes a groove positioned adjacent to said lip, said stop engaging the groove to maintain said brake safety member in the OFF position.

57. A brake mechanism according to claim 56, wherein said brake safety member further includes a sear contiguous with the groove, said stop engaging said sear, and an upper edge of the aperture engages said lip to maintain said brake safety member in the ON position.

58. A brake mechanism according to claim 49, wherein said brake safety member and said brake lever are integrally connected together via a resilient connecting member.

59. A brake mechanism according to claim 58, wherein said brake safety member and said brake lever are movable relative to each other.

60. A brake mechanism according to claim 49, further including a shield adapted to cover a wheel and shroud said brake sprocket.

61. A brake mechanism according to claim 60, wherein said shield includes a disk adapted to cover an inner side of the wheel and a generally cylindrical member collinearly arranged with the said and adapted to shroud said brake sprocket.

62. A brake mechanism according to claim 60, wherein said housing includes a generally cylindrical member sized to receive said cylindrical member of said shield.
